(19) United States
(12) Patent Application Publication
(10) Pub. No.: US 2003/0140899 A1
(43) Pub. Date: Jul. 31, 2003

(54) Control circuit for an actuator

(76) Inventor: Stephan Bolz, Pfatter (DE)

Correspondence Address: Bruce W. Slayden II, Baker Botts L.L.P., 910 Louisiana, Houston, TX, 77002, US

(21) Appl. No.: 10/348,866

(22) Filed: Jan. 22, 2003

(30) Foreign Application Priority Data
Jan. 22, 2002 (DE) 102 02 279.8

(51) Int. Cl. H01H 47/00

(52) U.S. Cl. 123/490; 361/152

(57) ABSTRACT

A control circuit for an actuator (1, 1.1, 1.2), in particular for an electromagnetic actuator for an injector of an injection system for an internal combustion engine, having a power supply (Vbat) and a first switching element (Q1), which is connected to the actuator (1, 1.1, 1.2) and to the power supply (Vbat), for switching the actuator (1, 1.1, 1.2) on or off, with the first switching element (Q1) being driven by a control signal (Vin), and having an energy storage element (C1), which is connected to the actuator (1, 1.1, 1.2), for temporary storage of at least a part of the energy which is stored in the actuator (1, 1.1, 1.2), while switching off the actuator (1, 1.1, 1.2) or for feeding back at least a part of the temporarily stored energy while the actuator (1, 1.1, 1.2) is once again switched on.

### PRIORITY

This application claims foreign priority of the German application DE 10202279.8 filed on Jan. 22, 2002.

### BACKGROUND OF THE INVENTION

The invention relates to a control circuit for an actuator, in particular for an electromagnetic actuator for an injector in an injection system for an internal combustion engine.

In injection systems for internal combustion engines, the fuel is injected into the individual combustion chambers of the internal combustion engine via injectors having an injection nozzle, with an electromagnetic actuator normally being provided in order to open or to close the injection nozzle.

The electromagnetic actuator is in this case driven by a control circuit, which either connects the actuator to a power supply, or disconnects it from the power supply, via a switching element.

One problem in this case is that the actuator current assumes the steady-state current value only relatively slowly when switching on or switching off, owing to the inductance of the actuator. This means that the nozzle needle of the injector assumes the desired state only relatively slowly and with a relatively long time delay when switching on or off, so that the dynamic control response of the known injectors is unsatisfactory.

This is particularly disadvantageous because accurate control of the injection time and duration, which can be selected as freely as possible, is important in order to reduce the exhaust gas emissions and to improve the smooth running of the internal combustion engine.

In order to improve the dynamic response when switching the actuator current off, it is known for a transistor, which is arranged on the ground side (low side), to be used for switching the actuator current, with a zener diode being connected between the gate and drain of the transistor. When the transistor changes to the switched-off state, the magnetic field in the actuator induces an opposing voltage which allows the drain voltage of the transistor to rise above the supply voltage and, in the end, leads to the transistor being switched on once again. The opposing voltage which is built up at the drain of the transistor in this case speeds up the decrease in the current, so that the actuator current assumes the steady-state zero value more quickly when switching off.

One disadvantage of this approach is that it runs counter to the current trend in the semiconductor industry to ever faster processes with lower breakdown voltages.

Secondly, a circuit arrangement such as this with a zener diode allows only the process for switching the actuator current off to be speeded up while, in contrast, it has no influence on the switching-on process.

### BACKGROUND OF THE INVENTION

The invention is therefore based on the object of improving the dynamic response, particularly when switching the actuator current on, for the known control circuits for actuators as described above.

This object can be achieved by a control circuit for an actuator, in particular an electromagnetic actuator for an injector of an injection system for an internal combustion engine, comprising:

a power supply,

a first switching element, which is connected to the actuator and to the power supply, for switching the actuator on or off, with the first switching element being driven by a control signal, and

an energy storage element, which is connected to the actuator, for temporary storage of at least a part of the energy which is stored in the actuator, while switching off the actuator and for feeding back at least a part of the temporarily stored energy while the actuator is once again switched on.

The energy storage device can be a capacitor, wherein the capacitance of the capacitor can be designed such that the voltage on the capacitor when receiving a part of the energy which is contained in the actuator is considerably greater than the voltage of the power supply. The energy storage element can be connected via a second switching element to the power supply, with the second switching element being driven by the control signal. The phases in which the first switching element is switched on and the phases in which the second switching element is switched on essentially can match. The actuator may be connected via a first diode to the energy storage element, with the first diode being connected such that it is forward-biased in the direction of the energy storage element. The voltage-side connection of the energy storage element can be connected via the first diode to the ground-side connection of the actuator, and is connected via the second switching element to the voltage-side connection of the actuator. The power supply can be connected via a second diode, with the second diode being connected such that it is reverse-biased in the direction of the power supply. A switching element can be in each case provided for separately driving a number of actuators, with the individual switching elements being driven by a respective control input, and the individual actuators being connected jointly to a single energy storage element. The control inputs can be jointly connected to the second switching element. The individual control inputs can be connected via an OR-Gate to the second switching element.

The invention includes the general technical teaching of connecting the actuator to an energy storage element, with the energy storage element temporarily storing at least a portion of the energy that is stored in the actuator when switching off the actuator current, and with at least a portion of the energy which is temporarily stored in the energy storage element being fed back into the actuator once again when the actuator current is subsequently switched on.

This temporary storage and feedback of the energy that is stored in the actuator advantageously speeds up the process of switching the actuator current on since there is no need to provide all the charge energy for the actuator from the power supply, and the energy which is temporarily stored in the energy storage element assists the charging process, or provides it on its own.

Furthermore, the temporary storage of the actuator energy can also speed up the discharging of the actuator. This is the case in particular when the energy storage element is connected for switching the actuator current off in such a way that the previous electrical voltage on the energy storage element assists the discharging of the actuator.

Thus, for the purposes of the invention, speeding up the switching processes for the actuator current advantageously improve the dynamic injection response, so that the injection time and duration can be controlled more accurately. This in turn makes it possible to reduce the exhaust gas emissions and to improve the smooth running of the internal combustion engine.

The actuator is preferably a conventional electromagnetic actuator, but the invention can also be used in conjunction with other actuator types in which the actuator current cannot change suddenly, owing to inductance.

A capacitor is preferably used for the purposes of the invention as the energy storage element for temporary storage of the actuator energy, with the capacitance of the capacitor preferably being designed such that the voltage on the capacitor after temporary storage of the energy which is stored in the actuator during the phase in which it is switched on is considerably greater than the normal supply voltage. A capacitor with a capacitance of such a magnitude offers the advantage that the greater charge voltage speeds up the process of charging the actuator when the actuator current is switched on.

However, the invention is not restricted to the use of a capacitor as the energy storage element. In fact, in principle, the invention can also be implemented with other types of energy storage devices which allow temporary storage of the energy contained in the actuator, during the phase in which the actuator is switched off.

The energy storage element is preferably connected via a further switching element to the power supply for the control circuit, with this further switching element preferably being driven by the same control signal as the switching element which switches the actuator current. The phases in which the two switching elements are switched on are in this case preferably essentially the same, so that the power supply charges not only the actuator but also the energy storage element in the phases in which the actuator is switched on. This is particularly advantageous when the actuator current is switched on for the first time, so that the energy storage element is in this way raised at least to the supply voltage during the first switching-on process.

The actuator is preferably connected to the energy storage element by means of a diode which is connected such that it is forward-biased in the direction of the energy storage element. This prevents the energy storage element from being discharged again in the opposite direction during the phases in which the actuator current is switched on.

However, the actuator may also be connected to the energy storage element in a similar way by means of a controlled transistor, which is switched off during the phases in which the actuator current is switched on, in order to prevent the energy storage element from being discharged during the phases in which the actuator current is switched on. When the actuator current is switched off, this transistor must be switched on, however, in order to allow the actuator to discharge into the energy storage element.

However, both the voltage-side connection of the actuator and the ground-side connection of the actuator are preferably connected to the voltage-side connection of the energy storage element, in each case via a diode or a switching element. This is worthwhile in order that the energy storage element is charged during the process of switching off the actuator current such that the energy which is temporarily stored in the energy storage element assists and speeds up the switching-on process when the actuator current is subsequently switched on.

Furthermore, the control circuit according to the invention is preferably connected to the power supply by means of a diode which is connected such that it is reverse-biased in the direction of the power supply. This means that the control circuit can only draw energy from the power supply while, in contrast, this prevents any reaction from the charge voltage on the energy storage element onto the power supply or other loads.

In one advantageous variant, the control circuit according to the invention has a number of actuators which each have an associated switching element for switching the actuator current on and off. In this case, however, the energy which is stored in the individual actuators is temporarily stored during a switching-off process by means of a single energy storage element. To do this, a number of actuators are preferably jointly connected to the energy storage element, with the connection in the simplest case being produced by a diode which is connected such that it is forward-biased in the direction of the energy storage element.

When the capacitor which is used as the energy storage element is discharging, the capacitor and the inductance of the actuator form a series resonant circuit, with the series resonant circuit being prevented from oscillating in the opposite direction by means of a diode. It can therefore be assumed, approximately, that the total energy

$$WL = \frac{1}{2} \cdot L \cdot {I}^{2}$$

of the inductance of the actuator is temporarily stored in the capacitor, with the energy content of the capacitor being calculated using the following formula:

$$WC = \frac{1}{2} \cdot C \cdot {U}^{2}$$

The charge voltage UCHARGE of the capacitor after the charge-reversal process is therefore obtained from the actuator current I, the inductance L of the actuator and the capacitance C1 of the buffer capacitor, as an approximation, using the following formula:

$$UCHARGE = \sqrt{\frac{L}{C1}} \cdot I$$

For a given actuator current I and a type-specific inductance L of the actuator, the capacitance C1 of the buffer capacitor is therefore preferably chosen to be sufficiently small that the charge voltage UCHARGE reaches the desired value UL,MIN. The capacitance C1 of the buffer capacitor is therefore preferably designed using the following formula:

$$C1 \leq \frac{L \cdot I}{{U}_{L , MIN}^{2}}$$

### BRIEF DESCRIPTION OF THE DRAWINGS

Other advantageous developments of the invention are characterized in the dependent claims or are explained in more detail in the following text together with the description of the preferred exemplary embodiment and with reference to the figures in which:

FIG. 1 shows a control circuit according to the invention, in the form of a circuit diagram,

FIG. 2 shows a number of signal diagrams for the control circuit from FIG. 1, and

FIG. 3 shows a modified exemplary embodiment of a control circuit according to the invention.

### DETAILED DESCRIPTION OF THE PREFERRED EMBODIMENTS

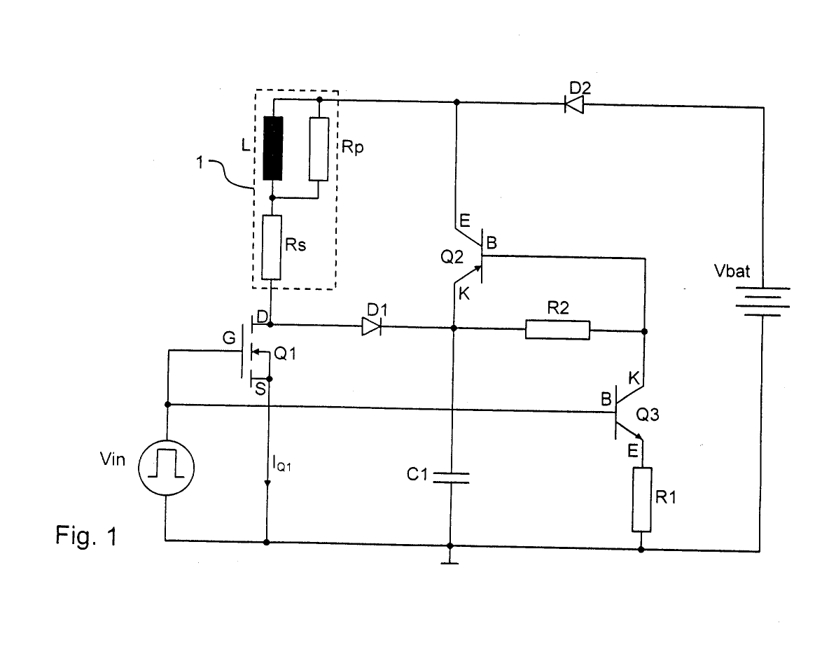

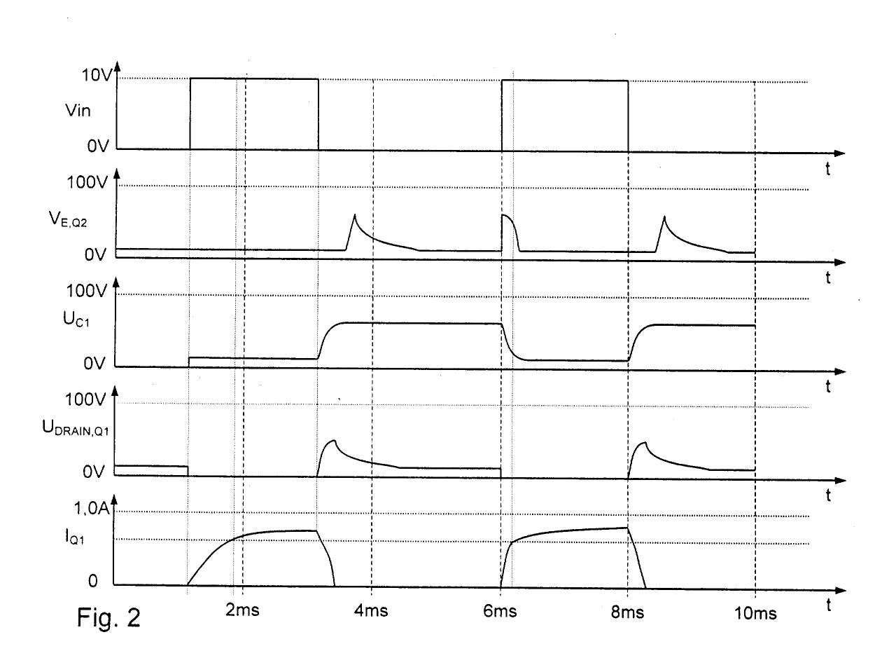

The physical construction of the control circuit according to the invention will be described first of all in the following text with reference to FIG. 1, in order then to explain the method of operation of the control circuit according to the invention, with reference to the signal diagrams showing in FIG. 2.

The control circuit according to the invention as illustrated in FIG. 1 is used for electrically driving an electromagnetic actuator 1 for an injection system for an internal combustion engine, with the actuator 1 operating the nozzle needle of an injector and being represented in simplified form as an equivalent circuit composed of an ideal inductance L=10 mH, a parallel resistance Rp=1200 Ω and a series resistance Rp=12 Ω.

The actuator 1 is connected via a transistor Q1 and a diode D2 to a power supply Vbat=12 V, with the diode D2 being connected such that the power supply Vbat charges the actuator 1 when the transistor Q2 is switched on.

The gate connection G of the transistor Q1 is in this case connected to a control signal Vin, which is produced by the electronic engine controller for the internal combustion engine and assumes either a high level VHIGH=10 V or a low level VLOW=0 V.

When the control signal is at a high level, the transistor Q1 is switched on, so that the power supply Vbat charges the actuator 1 with a time constant τON=L/RS.

The drain connection D of the transistor Q1 is connected via a diode D1 and a capacitor C1=2 μF to ground, so that the actuator current can continue to flow via the diode D1 and the capacitor C1 when the transistor Q1 is switched off, as a result of which the capacitor C1 is charged to around 55 V.

Furthermore, a transistor Q2 is provided with the emitter E of the transistor Q2 being connected to the voltage-side connection of the actuator 1, while the collector K of the transistor Q2 is connected to the junction point between the diode D1 and the capacitor C1.

Thus, when the transistor Q2 is switched on, the power supply Vbat can charge the capacitor C1 via the transistor Q2. Furthermore, the capacitor C1 can drive a charging current through the actuator 1, when the two transistors Q1 and Q2 are switched on, thus speeding up the switching-on process.

Furthermore, the control signal Vin is also supplied to the base B of a transistor Q3, whose emitter E is connected via a resistor, R1=1 kΩ to ground. This means that the transistor Q3 is switched on only during the phases in which the actuator current is switched on, and is switched off during the phases in which the actuator current is switched off.

The collector K of the transistor Q3 is in turn connected to the base B of a transistor Q2, so that the transistor Q2 is also switched on during the phases in which the actuator current is switched on, and is switched off during the phases in which the actuator current is switched off.

Finally, the emitter E of the transistor Q3 is connected via a resistor R2=10 kΩ to the collector K of the transistor Q2.

The method of operation of the control circuit according to the invention will now be described in the following text with reference to the signal diagrams illustrated in FIG. 2.

The uppermost signal diagram in FIG. 2 thus shows the time profile of the control signal Vin over a number of switched-on and switched-off phases, with a high level VHIGH=10 V of the control signal Vin leading to the transistors Q1, Q2 and Q3 being switched on while, in contrast, the transistors Q1, Q2 and Q3 are switched off while the control signal Vin is at a low level VLOW=0 V.

The signal diagram below this shows the time profile of the electrical voltage at the emitter E of the transistor Q2, with this voltage forming the charging voltage for the actuator 1, as will be explained in detail later.

Furthermore, the third signal diagram in FIG. 2 shows the time profile of the voltage on the capacitor C1, and which is dropped at the collector K of the transistor Q2.

In addition, the fourth signal diagram in FIG. 2 shows the time profile of the voltage at the drain connection D of the transistor Q1.

Finally, the lowermost signal diagram in FIG. 2 shows the time profile of the drain current through the transistor Q1.

At the time tON, the control signal Vin changes from a low level VIN=0 V to a high level VIN=10 V by virtue of an external drive from the engine controller for the internal combustion engine.

This results in the transistor Q1 being switched on, so that the power supply Vbat drives a charging current through the actuator 1 and through the switched-on transistor Q1, with the charging current rising exponentially.

Furthermore, the high level of the control signal also leads to the transistor Q3 being switched on, and hence also the transistor Q2 being switched on, so that the power supply Vbat also charges the capacitor C1 to the supply voltage Vbat=12 V, via the transistor Q2.

When the control signal Vin changes from a high level to a low level at the time tOFF by virtue of the external drive by the engine controller, then the transistor Q1 is switched off first of all, so that the actuator current can no longer flow via the transistor Q1. However, owing to the inductance L of the actuator 1, the actuator current cannot suddenly fall to zero when the transistor Q1 is switched off, so that the actuator current initially continues to flow via the diode D1 and the capacitor C1, with the capacitor C1 being charged to a voltage of 55 V, while the actuator current decreases exponentially to zero.

When the control signal Vin is driven with a high level once again, the transistors Q1, Q2 and Q3 are switched on once again, so that the charge voltage of the capacitor C1 of 55 V is now dropped at the emitter E of the transistor Q2. In consequence, the diode D2 then becomes reverse-biased, as the voltage of the power supply Vbat=12 V is considerably lower. The capacitor C1 is therefore discharged via the transistor Q2, the actuator 1 an the transistor Q1, with the charging process taking place considerably more quickly, owing to this considerably greater charge voltage on the capacitor C1, than when the actuator 1 was initially charged with the supply voltage Vbat=12. The first switching-on process with the actuator current reaching 0.6 A therefore last for around 0.88 ms, while the subsequent switching-on processes each last for only 0.14 ms. In the process, the capacitor voltage falls to about 11.3 V, since the diode D2 becomes forward-biased once again then.

If the control signal Vin then once again changes suddenly to a low level, then the discharging process described above is repeated.

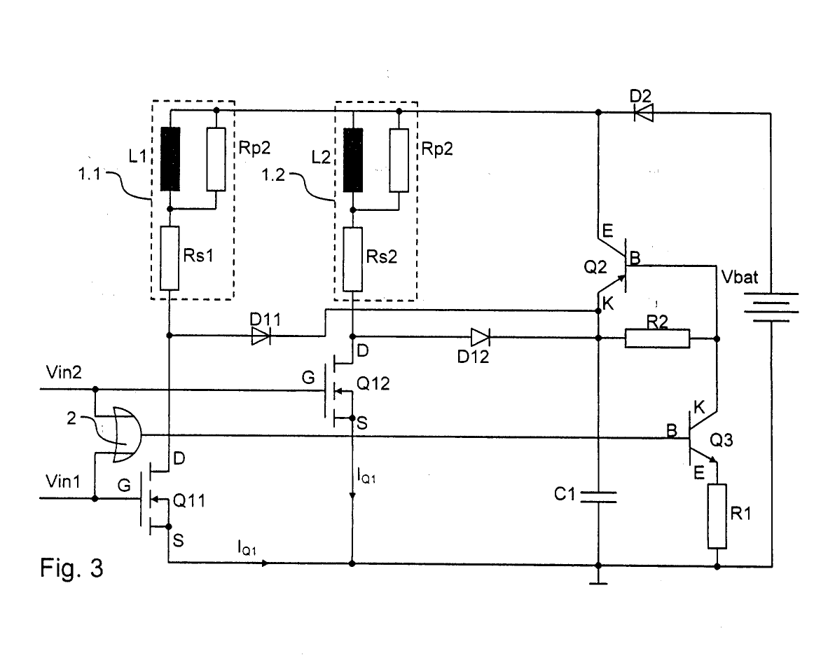

The exemplary embodiment of a control circuit according to the invention as illustrated in FIG. 3 corresponds largely to the exemplary embodiment described above and illustrated in FIG. 1, so that the same reference symbols are used in the following text for components which correspond to one another, and reference is largely made to the above description related to FIG. 1, in order to avoid repetitions.

The special feature of this exemplary embodiment is that the control circuit drives a number of actuators 1.1, 1.2, which are each associated with one combustion chamber of an internal combustion engine. The actuators 1.1, 1.2 are in this case driven by a respective transistor Q11 or Q12 in the manner described above by means of a respective control signal Vin1 or Vin2.

The central feature in this case is that only a single capacitor C1 is provided to assist the process of charging the actuators 1.1 and 1.2.

While the actuator current for the actuator 1.1 is switched off, this actuator 1.1 is discharged via the diode D11 into the capacitor C1, while the actuator 1.2 is discharged in the same way, on being switched off, via the diode D12 into the capacitor C1.

The circuit is enlarged to four or more injection valves in an analogous manner, with one common capacitor C1 being sufficient in this case.

The switching-on process is in this case likewise assisted in the manner described above, with the two control signals Vin1 and Vin2 being connected via an OR gate 2 to the base B of the transistor Q3.

However, overlapping of the switched-on times should be avoided in this exemplary embodiment, in order to ensure correct operation.

1. A control circuit for an actuator for an injector of an injection system for an internal combustion engine, comprising:
a power supply,
a first switching element, which is connected to the actuator and to the power supply, for switching the actuator on or off, with the first switching element being driven by a control signal, and
an energy storage element, which is connected to the actuator, for temporary storage of at least a part of the energy which is stored in the actuator, while switching off the actuator and for feeding back at least a part of the temporarily stored energy while the actuator is once again switched on.

2. The control circuit as claimed in claim 1, wherein the energy storage device is a capacitor.

3. The control circuit as claimed in claim 2, wherein the capacitance of the capacitor is designed such that the voltage on the capacitor when receiving a part of the energy which is contained in the actuator is considerably greater than the voltage of the power supply.

4. The control circuit as claimed in claim 1, wherein the energy storage element is connected via a second switching element to the power supply, with the second switching element being driven by the control signal.

5. The control circuit as claimed in claim 4, wherein the phases in which the first switching element is switched on and the phases in which the second switching element is switched on essentially match.

6. The control circuit as claimed in claim 1, wherein the actuator is connected via a first diode to the energy storage element, with the first diode being connected such that it is forward-biased in the direction of the energy storage element.

7. The control circuit as claimed in claim 4, wherein the voltage-side connection of the energy storage element is connected via the first diode to the ground-side connection of the actuator, and is connected via the second switching element to the voltage-side connection of the actuator.

8. The control circuit as claimed in claim 1, wherein the power supply is connected via a second diode, with the second diode being connected such that it is reverse-biased in the direction of the power supply.

9. The control circuit as claimed in claim 1, wherein a switching element is in each case provided for separately driving a number of actuators, with the individual switching elements being driven by a respective control input, and the individual actuators being connected jointly to a single energy storage element.

10. The control circuit as claimed in claim 9, wherein the control inputs are jointly connected to the second switching element.

11. The control circuit as claimed in claim 10, wherein the individual control inputs are connected via an OR-Gate to the second switching element.

12. A control circuit for an electromagnetic actuator for an injector of an injection system for an internal combustion engine, comprising:
a power supply,
a first switching element, which is connected to the actuator and to the power supply, for switching the actuator on or off, with the first switching element being driven by a control signal, and
an energy storage element, which is connected to the actuator, for temporary storage of at least a part of the energy which is stored in the actuator, while switching off the actuator and for feeding back at least a part of the temporarily stored energy while the actuator is once again switched on.

13. The control circuit as claimed in claim 12, wherein the storage element is a capacitor and the capacitance of the capacitor is designed such that the voltage on the capacitor when receiving a part of the energy which is contained in the actuator is considerably greater than the voltage of the power supply.

14. The control circuit as claimed in claim 12, wherein the energy storage element is connected via a second switching element to the power supply, with the second switching element being driven by the control signal.

15. The control circuit as claimed in claim 13, wherein the phases in which the first switching element is switched on and the phases in which the second switching element is switched on essentially match.

16. The control circuit as claimed in claim 12, wherein the actuator is connected via a first diode to the energy storage element, with the first diode being connected such that it is forward-biased in the direction of the energy storage element.

17. The control circuit as claimed in claim 13, wherein the voltage-side connection of the energy storage element is connected via the first diode to the ground-side connection of the actuator, and is connected via the second switching element to the voltage-side connection of the actuator.

18. The control circuit as claimed in claim 12, wherein the power supply is connected via a second diode, with the second diode being connected such that it is reverse-biased in the direction of the power supply.

19. The control circuit as claimed in claim 12, wherein a switching element is in each case provided for separately driving a number of actuators, with the individual switching elements being driven by a respective control input, and the individual actuators being connected jointly to a single energy storage element.

20. The control circuit as claimed in claim 12, wherein the control inputs are jointly connected to the second switching element.
